(19) United States
(12) Patent Application Publication
(10) Pub. No.: US 2009/0090757 A1
(43) Pub. Date: Apr. 9, 2009

(54) CRADLE FOR AUTOMOBILE

(76) Inventors: Han Soo KIM, Seoul-si (KR); Youn Ui Jeong, Seoul-si (KR); Byung Mu Huh, Seoul-si (KR); Soung Hyun Um, Anyang-si (KR)

Correspondence Address: BIRCH STEWART KOLASCH & BIRCH, PO BOX 747, FALLS CHURCH, VA, 22040-0747, US

(21) Appl. No.: 12/243,730

(22) Filed: Oct. 1, 2008

(30) Foreign Application Priority Data
Oct. 5, 2007 (KR) 10-2007-0100440

(51) Int. Cl. B60R 7/00; F16B 47/00; B60R 11/00

(52) U.S. Cl. 224/559; 248/206.2; 248/205.8

(57) ABSTRACT

The present invention relates to a cradle for an automobile. The present invention provides a cradle for an automobile comprising a mounting plate having a front surface to which a device for an automobile is mounted; and a suction plate pivotally coupled to the mounting plate to be selectively folded onto the mounting plate, the suction plate being selectively attached and fixed to a bottom surface. In addition, the cradle further comprises a supporting link rotatably installed to the suction plate and provided with a head portion pivotally coupled to the mounting plate. According to the present invention as described above, the cradle is carried or kept in a state where the cradle is folded with respect to the device. Thus, there is an advantage in that the overall volume of the cradle and device for an automobile is reduced.

### BACKGROUND OF THE INVENTION

1. Field of the Invention

The present invention relates to a cradle for an automobile, more particularly, to a cradle for an automobile to which every kind of device for an automobile used in an interior thereof by a driver is mounted.

2. Description of the Prior Art

In recent, devices for automobile such as a portable terminal having a digital multimedia broadcasting (DMB) function, a navigator providing a driver with the information regarding traffic conditions in real time, and the like have been developed rapidly. In particular, the aforementioned devices for an automobile are installed to an interior thereof to provide a driver with much information and entertainment. Accordingly, in order to allow a driver to obtain various kinds of information during a driving, a cradle for an automobile, which fixedly mounts a device for an automobile to an interior of an automobile, has been sold in the markets in large quantities, and development of the cradle has been accelerated.

FIG. 1 is a perspective view showing an external appearance of a conventional cradle for an automobile.

As shown in the figure, a cradle for an automobile is provided with a main body 2 for supporting a rear surface of a device for an automobile. A pair of supporters 4 are provided at a lower portion of the main body 2 and protrude forward from the main body 2. The supporters 4 are parts for supporting a lower surface of the device for an automobile.

In addition, pressing members 6 are provided at both sides of the main body 2, respectively. The pressing members 6 serve to press both side surfaces of the device for an automobile to support the device. The pressing members 6 are mounted so that at least one of the pressing members slides in the horizontal direction with respect to the main body 2. Accordingly, the pressing members 6 are freely adjusted according to a dimension of the device for an automobile to press both the side surfaces thereof. In addition, the pressing members 6 are not only slidably installed but also can slide in the horizontal direction by means of a coil spring provided in the main body 2.

In addition, sponges 8 are respectively provided on inner surfaces of the pressing members 6 to face each other. The friction between the sponge 8 and the device for an automobile causes the device not to slide downward. The sponge 8 is attached to the inner surface of the pressing member 6 through a double-sided tape.

In the meantime, a hose 10 is provided at one side of a rear surface of the main body 2 to extend rearward of the main body 2. The hose 10 can be freely bent according to the movement of the main body 2 and is connected to a suction member 12. The suction member 12 is a part by which the main body 2 is attached to an interior of an automobile.

In the conventional art having the aforementioned configuration, a user puts a device for an automobile on the main body 2 and slides the pressing members 6 inwardly so that the distance between the pressing members is the size of the device to fix it. At this time, the supporter 4 supports a lower surface of the device for an automobile. Then, the user operates an interface of the device to watch a program on a desired channel or obtain every kind of information.

However, the conventional cradle for an automobile according to the prior art as described above has a problem as follows.

Recently, automobiles in which devices for an automobile such as a navigator are mounted have been rapidly increased. In general, a navigator is mounted to an inner surface of a windshield of an automobile, so that men can easily see from the outside whether the navigator is mounted in the automobile or not. Due to the above configuration, larcenists who break a windshield of an automobile and steal a navigator mounted in an automobile are increased day by day. Such a problem has been recognized as the biggest trouble in United State as well as Europe.

As described above, in order to prevent the navigator from being stolen, the user separates the navigator and the cradle from the windshield after driving an automobile and then keeps them in a receiving box provided in the automobile or in a house. In the cradle for an automobile according to the prior art, however, since the main body 2 and the suction member 12 are connected to the hose 10, the cradle has a large volume which is in proportion to a distance between the main body and the suction member. Due to the large volume of the cradle for an automobile as described above, it is not easy to separate the cradle from an automobile and keep it safe.

Accordingly, since it is not easy to separate a large-volumed cradle for an automobile together with a navigator from a windshield and it is inconvenient to carry the cradle together with the navigator, there are instances where a driver leaves a navigator in an automobile, which ultimately results in theft of a navigator.

In addition, since the cradle for an automobile as described above has a large volume, a user separates the cradle from a navigator and keeps separately the cradle and the navigator, rather than keeping the cradle along with the navigator. Thus, there is a problem in that a user feels it inconvenient.

### SUMMARY OF THE INVENTION

The present invention is conceived to solve the above problems of the prior art as described above, an objective of the present invention is to provide a cradle for an automobile with a structure to have a small overall volume together with a device for an automobile when the cradle is detached from an automobile.

According to an aspect of the present invention for achieving the objects, there is provided a cradle for an automobile, which comprises a mounting plate having a front surface to which a device for an automobile is mounted; and a suction plate pivotally coupled to the mounting plate to be selectively folded with respect to a rear surface of the device, the suction plate being selectively attached and fixed to a bottom surface.

The cradle may further comprise a supporting link rotatably installed to the suction plate and provided with a head portion pivotally coupled to the mounting plate.

The supporting link may comprise a rotating portion rotatably installed to the suction plate; a neck portion extending from a center of the rotating portion; and a spherical head portion provided at a leading end of the neck portion and pivotally coupled to the mounting plate.

The mounting plate may be provided with a protrusion, which protrudes to be pivotally coupled with the supporting link.

A head coupling portion may be concavely formed on the protrusion so that the head portion is pivotally coupled to the head coupling portion, and a link seating portion corresponding to the neck portion may be formed on the protrusion to communicating with the head coupling portion.

The suction plate may comprise a suction plate body; a suction member provided in a lower portion of the suction plate body to be movable relatively to the suction plate body, the suction member being selectively attached to the bottom surface while a portion except a periphery of the suction member is raised upward; a suction boss protruding on an upper surface of the suction plate body and provided with a button for adjusting the attachment of the suction member; and an operating lever rotatably installed to the suction boss, the operating lever being rotated in one direction to maintain an attached state of the suction member in a state where the button is pressed.

The rotating portion and the operating lever may be rotatably installed at positions symmetric with each other about the suction boss and selectively seated on a periphery region of the upper surface of the suction plate body.

According to another aspect of the present invention, there is provided a cradle for an automobile, which comprises a mounting plate having a front surface to which a device for an automobile is mounted and a rear surface on which a protrusion protrudes; a supporting link provided with a head portion pivotally coupled to a head coupling portion concavely formed on the protrusion; and a suction plate rotatably installed to the supporting link to be selectively folded with respect to a rear surface of the device, the suction plate being selectively attached and fixed to a bottom surface.

The supporting link may be provided with a neck portion connecting the head portion thereto, and the neck portion may be selectively seated on a link seating portion communicating with the head coupling portion.

The suction plate may comprise a suction plate body; a suction member provided in a lower portion of the suction plate body to be movable relatively to the suction plate body, the suction member being selectively attached to the bottom surface while a portion except a periphery of the suction member is raised upward; a suction boss protruding on an upper surface of the suction plate body and provided with a button for adjusting the attachment of the suction member; and an operating lever rotatably installed to the suction boss, the operating lever being rotated to maintain an attached state of the suction member in a state where the button is pressed.

The supporting link and the operating lever may be rotatably installed at positions symmetric with each other about the suction boss, respectively, and selectively seated on a periphery region of the upper surface of the suction plate body.

Several preferred embodiments of the present invention will be described in more detail below with reference to accompanying drawings, from which the characteristics and advantages of the present invention will become more apparent.

### BRIEF DESCRIPTION OF THE DRAWINGS

The above and other objects, features and advantages of the present invention will be more apparent after reading the following detailed description taken in conjunction with the accompanying drawings, in which:

FIG. 1 is a perspective view showing an external appearance of a general cradle for an automobile;

FIG. 2 is a perspective view showing a state where a device for an automobile is mounted to a cradle for an automobile according to the preferred embodiment of the present invention;

FIG. 3 is a side view showing a state where the cradle according to the present invention is unfolded;

FIG. 4 is a side view showing a state where the cradle according to the present invention is folded; and

FIGS. 5a to 5c are side views illustrating a process of fixing the cradle according to the present invention.

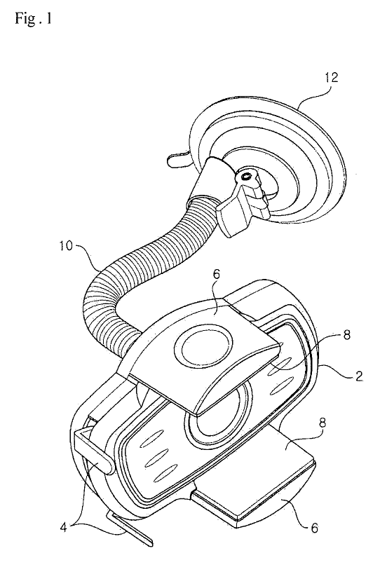

### DETAILED DESCRIPTION OF THE PREFERRED EMBODIMENTS

Hereinafter, a preferred embodiment of the present invention will be described in more detail with reference to the accompanying drawings. In the following description and drawings, the same reference numerals are used to designate the same or similar components.

Hereinafter, a preferred embodiment of a cradle for an automobile according to the present invention will be described in detail with reference to the accompanying drawings.

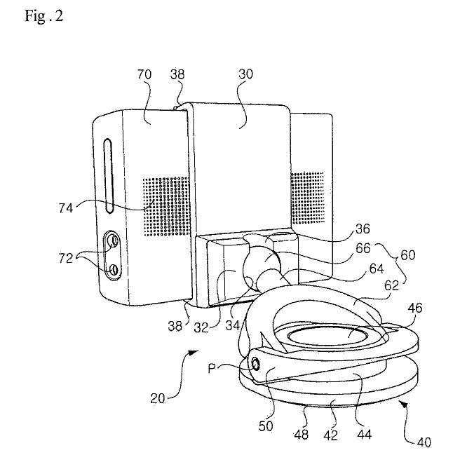

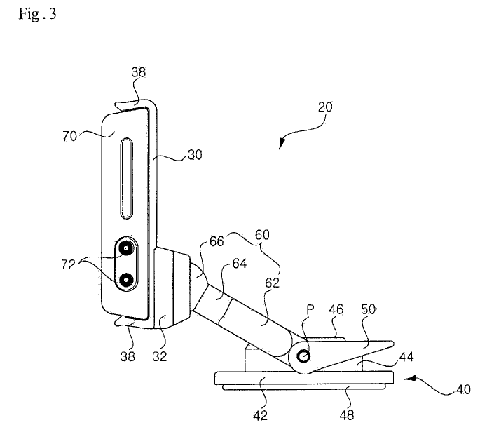

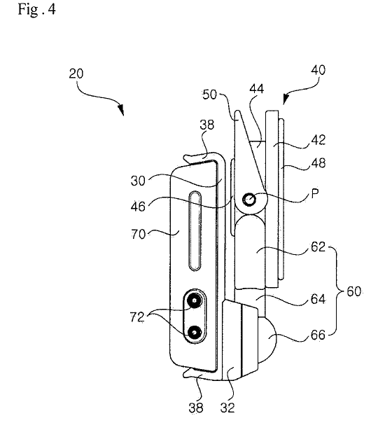

FIG. 2 is a perspective view showing a preferred embodiment of a cradle for an automobile according to the present invention, FIG. 3 is a side view showing a state where the cradle according to the present invention is unfolded, and FIG. 4 is a side view showing a state where the cradle according to the present invention is folded.

As shown in the figures, a cradle 20 for an automobile mounted to an interior of an automobile includes a mounting plate 30 and a suction plate 40. The mounting plate 30 is formed in the shape of an approximate plate and is a part to which a device 70 for an automobile is mounted. The device 70 is mounted to a front surface of the mounting plate 30, and a protrusion 32 is formed on a rear surface of the mounting plate 30. The protrusion 32 has a certain volume and protrudes from the rear surface of the mounting plate 30. The protrusion 32 is formed at a lower portion of the rear surface of the mounting plate 30.

A head coupling portion 34, with which a head portion 66 to be described below is pivotally coupled, is concavely formed on the protrusion 32. The head coupling portion 34 has the concave shape corresponding to the shape of the head portion 66 and is formed to partially cover the head portion 66. Here, the head coupling portion 34 should be designed to meet the following conditions. First, in a state where the cradle 20 for an automobile is assembled, the head coupling portion should fasten the head portion 66 so that it can be rotated at a desired angle if a user applies a force thereto. In addition, the head coupling portion should also fasten the head portion 66 so that the mounting plate 30 and the device 70 mounted thereto can be supported unless external force is exerted thereon after the head portion 66 is rotated at a desired angle by a user.

In addition, a link seating portion 36 communicating with the head coupling portion 34 is formed on the protrusion 32. The link seating portion 36 is a portion in which a neck portion 64 of a supporting link 60 to be described later is seated when the suction plate 40 to be described below is folded onto the rear surface of the mounting plate 30. Accordingly, the link seating portion 36 has a shape corresponding to the neck portion 64. In this embodiment, the link seating portion 36 is formed to be opened upward and downward of the protrusion 32 in order to prevent the neck portion 64 from interfering with the link seating portion when the supporting link 60 is rotated.

In the meantime, coupling hooks 38 are provided at upper and lower ends of the mounting plate 30, respectively. The coupling hooks 38 are made of elastically deformable material, so that they are elastically deformed and coupled to upper and lower ends of the device 70 for an automobile to support the device 70.

The mounting plate 30 is equipped with the suction plate 40 which is selectively folded with respect to a rear surface of the device 70 for an automobile. The suction plate 40 is pivotally coupled to the mounting plate 30 in order to secure various viewing angles. More specifically, the suction plate 40 is pivotally coupled to the mounting plate 30 by the supporting link 60 which will be described later. The suction plate 40 is a member to be fixed to an interior of an automobile, so that in a state where the suction plate 40 is fixed to an interior of an automobile, a user can rotate the mounting plate 30 in front, rear, left and right side directions to observe the device 70 at a desired angle.

The suction plate 40 is provided with a suction plate body 42 defining an external appearance thereof The suction plate body 42 has a predetermined thickness and is formed in the shape of a circular plate. A suction boss 44 is provided on an upper surface of the suction plate body 42. The suction boss 44 is formed in the shape of a cylinder having a diameter relatively smaller than that of the suction plate body 42. The suction boss 44 may be formed independently of the suction plate body 42, but preferably formed integrally with the suction plate 42. In addition, an inner space is formed in the suction plate body 42 and the suction boss 44 so that parts for adjusting a suction member 48 to be described later can be received in the inner space.

A button 46 is provided inside of the suction plate 44. The button 46 is a part manipulated by a user's hand when the suction plate 40 is fixed to an interior of an automobile.

In addition, the suction member 48 is provided in a lower portion of the suction plate body 42 so that the suction member can be moved upward and downward relatively to the suction plate body 42. The suction member 48 is not directly coupled to the suction plate body 42 but moveably coupled thereto through an additional part. For example, the suction member 48 may be configured so that it is supported by an elastic member providing elastic force in a direction in which the suction plate 48 comes into contact with a bottom surface. Such a configuration of the suction member 48 has been well known, and various modified configurations thereof can be applied thereto in addition to the above structure, so that details thereon will be omitted.

The suction member 48 is a part to be substantially attached to a bottom surface and a windshield of an automobile. The suction member 48 is made of a synthetic resin, rubber, flexible material and the like to attach the cradle 20 for an automobile to a windshield using suction force. That is, in a state where the suction member 48 is placed on a windshield, if a user manipulates the button 46 and an operating lever 50, a portion of the suction member 48 except a periphery region is raised upward to fix the cradle 20 to the windshield by the suction force. At this time, a rise of the central region of the suction member 48 is effected while overcoming the elastic force of the elastic member.

In the meantime, the operating lever 50 is provided on the suction boss 44 to be rotatable through a hinge pin P. The operating lever 50 is rotatably coupled to a side surface of the suction boss 44 and selectively seated on a periphery of the upper surface of the suction plate body 42. Specifically, the operating lever 50 is formed in the shape of a circular arc having a central angle of approximately 180 degrees and has a lower portion partially removed to allow a user to easily grip the operating lever in a state where the operating lever is placed on the upper surface of the suction plate body 42.

The operating lever 50 serves to attach or release the suction member 48 to or from a windshield. The operating lever 50 is rotated directly upward with respect to the suction boss 44 within a range of approximately 90 degrees. That is, if the operating lever 50 is rotated directly upward by 90 degrees with respect to the suction plate body 42, the attachment of the suction member 48 is released, and if the operating lever 50 is rotated so that the operating lever is seated on the periphery of the upper surface of the suction plate body 42 in a state where the button 46 is pressed, the suction member 48 is attached to the windshield.

In the meantime, the supporting link 60 is provided rotatably on the suction boss 44. The supporting link 60 serves to link the mounting plate 30 and the suction plate 40, so that the mounting plate 30 can be supported at a predetermined angle relative to the suction plate 40. The supporting link 60 is provided with a rotating portion 62 that is rotatably installed to the suction boss 44. Like the operating lever 50, the rotating portion 62 is coupled to the suction boss 44 through the hinge pin P. The rotating portion 62 is formed in the shape of a circular arc having a central angle of approximately 180 degrees.

Referring to FIGS. 2 and 3, the operating lever 50 and the rotating portion 62 are rotated about the suction boss 44 in opposite directions to each other and then seated on the periphery of the upper surface of the suction plate body 42, respectively. That is, the to operating lever 50 and the rotating portion 62 are installed to be symmetrically rotated about the suction boss 44 and seated on the periphery of the upper surface of the suction plate body 42, thereby defining a tidy external appearance.

The neck portion 64 is provided on the center of the rotating portion 62 to extend therefrom. The neck portion 64 is formed in the shape of an approximate bar. In is addition, the spherical head portion 66 is formed at a leading end of the neck portion 64. The head portion 66 has the diameter relatively larger than that of the neck 64 and is pivotally coupled to the head coupling portion 34.

In the meantime, the mounting plate 30 is mounted with the device 70 for an automobile, such as a navigator, a DMB terminal and the like. The device 70 has an approximately flat rectangular hexahedral shape. A jack connecting portion 72 into which an earphone jack can be inserted is formed on a side surface of the device 70 for an automobile. In addition, a plurality of heat radiating holes 74 are formed on the rear surface of the device 70 for radiating heat generated in the device 70 to the outside.

Hereinafter, the operation and function of the cradle for an automobile according to the present invention having the above configurations will be described in detail.

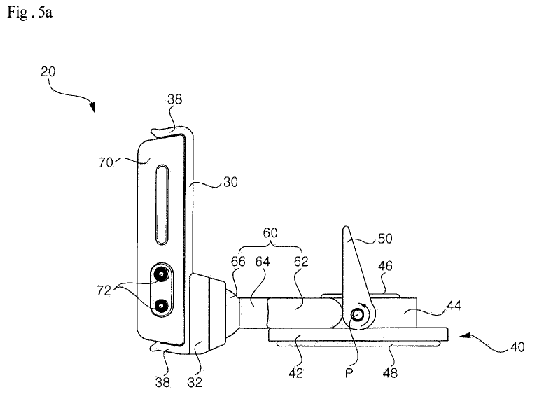

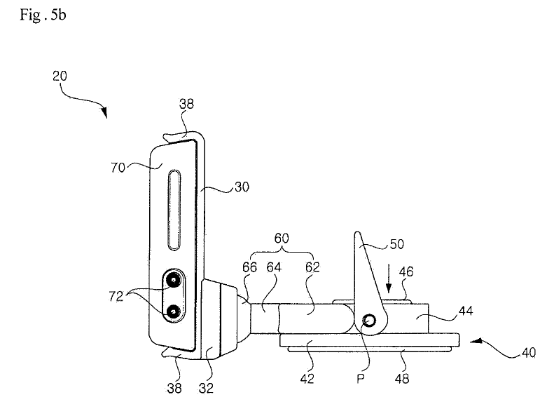

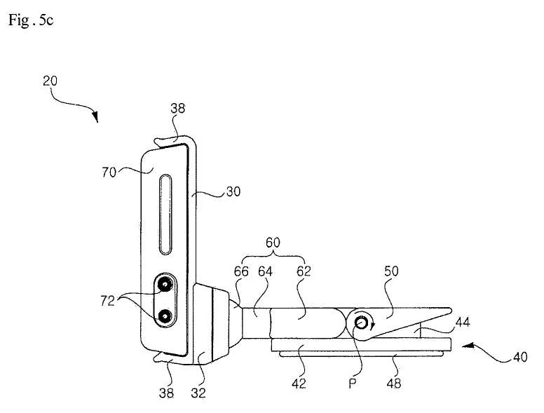

First of all a process of attaching the cradle 20 for an automobile to a windshield of the automobile will be described in detail. FIGS. 5a to 5c are side views illustrating a process for fixing the cradle according to the present invention.

According to the figures, as shown in FIG. 5a, the cradle 20 for the automobile is placed on a windshield to which the cradle will be mounted. At this time, the operating lever 50 is rotated directly upward with respect to the suction plate body 42 to maintain the attachment release state of the suction member 48. In the attachment release state, the suction member 48 becomes overall flat. Accordingly, the suction member 48 comes into close contact with a desired position of the windshield.

Next, a user presses the button 46 provided inside of the suction boss 44 (see FIG. 5b). In a state where the button 46 is pressed, if the operating lever 50 is rotated so that the operating lever is seated on the upper surface of the suction plate body 42, the central portion of the suction member 48 except the periphery region is raised upward and then the suction member 48 is attached to the windshield by suction force (see FIG. 5c). That is, in the process of rotating the operating lever 50, the central portion of the suction member 48 overcomes the elastic force of the elastic member provided in the suction plate body 42 and thus the suction member 48 is attached to the windshield.

As described above, in order to release the attached state of the cradle 20 fixed to the windshield, the operating lever 50 is rotated directly upward with respect to the suction plate body 42. Then, the central portion of the suction member 48 is lowered by the elastic force of the elastic member and the suction member is restored to its original state. In this state, the suction member 48 becomes flat again and the user can easily detach the cradle 20 from the windshield.

Through the aforementioned process, the cradle 20 for an automobile can be freely attached to and detached from a windshield of an automobile. Accordingly, after driving, the user detaches the cradle 20 from the windshield as described above in order to prevent the cradle 20 from being stolen. In addition, the user rotates the operating lever 50 and the supporting link 60 to be seated on the upper surface of the suction plate body 42. Then, the user rotates the suction plate 40 to make the suction plate 40 be brought into contact with the rear surface of the device 70 for an automobile, which is well illustrated in FIG. 3. At this time, the neck portion 64 of the supporting link 60 is seated on the link seating portion 36.

As described above, if the suction plate 40 is folded with respect to the device 70, the cradle 20 and the device 70 has a compact external appearance as well known from FIG. 3. That is, as compared with a conventional cradle for an automobile, an overall thickness of the cradle 20 and device 70 for an automobile become small and the volume of the cradle 20 is also reduced. Thus, the user conveniently carries the cradle for an automobile. In addition, when the cradle 20 is folded with respect to the device 70, the overall volume of the cradle 20 and device 70 is small so that it is easy to keep the cradle 20 and device 70 in a separate receiving box provided in an automobile. As a result, after detaching the cradle 20, the user conveniently carries or keeps the cradle together with the device 70.

The present invention is configured so that the suction plate is folded with respect to a rear surface of the device for an automobile with the mounting plate interposed therebetween. Accordingly, in a state where the device is mounted to the cradle, after the cradle is detached from a windshield, the suction plate is folded thereby decreasing the overall volume of the cradle. Consequently, in a state where the device and cradle for an automobile are separated, a user can conveniently carry or keep the cradle and device for an automobile. As described above, since the user can separate and keep the device and cradle for an automobile more actively, there is an advantage that the device for an automobile is prevented from being stolen.

Although several preferred embodiments of the present invention have been disclosed for illustrative purposes, it should be understood that numerous modifications and embodiments can be devised by those skilled in the art that will fall within the spirit and scope of the principles of this disclosure. More particularly, various variations and modifications are possible in the component parts and/or arrangements of the subject combination arrangement within the scope of the disclosure, the drawings and the appended claims. In addition to variations and modifications in the component parts and/or arrangements, alternative uses will also be apparent to those skilled in the art.

What is claimed is:

1. A cradle for an automobile, comprising:
a mounting plate having a front surface to which a device for an automobile is mounted; and
a suction plate pivotally coupled to the mounting plate to be selectively folded with respect to a rear surface of the device, the suction plate being selectively attached and fixed to a bottom surface.

2. The cradle claimed in claim 1, further comprising a supporting link rotatably installed to the suction plate and provided with a head portion pivotally coupled to the mounting plate.

3. The cradle claimed in claim 2, wherein the supporting link comprises a rotating portion rotatably installed to the suction plate; a neck portion extending from a center of the rotating portion; and a spherical head portion provided at a leading end of the neck portion and pivotally coupled to the mounting plate.

4. The cradle claimed in claim 3, wherein the mounting plate is provided with a protrusion, which protrudes to be pivotally coupled with the supporting link.

5. The cradle claimed in claim 4, wherein a head coupling portion is concavely formed on the protrusion so that the head portion is pivotally coupled to the head coupling portion, and a link seating portion corresponding to the neck portion is formed on the protrusion to communicating with the head coupling portion.

6. The cradle claimed any one of claims 1 to 5, wherein the suction plate comprises a suction plate body; a suction member provided in a lower portion of the suction plate body to be movable relatively to the suction plate body, the suction member being selectively attached to the bottom surface while a portion except a periphery of the suction member is raised upward; a suction boss protruding on an upper surface of the suction plate body and provided with a button for adjusting the attachment of the suction member; and an operating lever rotatably installed to the suction boss, the operating lever being rotated in one direction to maintain an attached state of the suction member in a state where the button is pressed.

7. The cradle claimed in claim 6, wherein the rotating portion and the operating lever are rotatably installed at positions symmetric with each other about the suction boss and selectively seated on a periphery region of the upper surface of the suction plate body.

8. A cradle for an automobile, comprising:
a mounting plate having a front surface to which a device for an automobile is mounted and a rear surface on which a protrusion protrudes;
a supporting link provided with a head portion pivotally coupled to a head coupling portion concavely formed on the protrusion; and
a suction plate rotatably installed to the supporting link to be selectively folded with respect to a rear surface of the device, the suction plate being selectively attached and fixed to a bottom surface.

9. The cradle claimed in claim 8, wherein the supporting link is provided with a neck portion connecting the head portion thereto, and the neck portion is selectively seated on a link seating portion communicating with the head coupling portion.

10. The cradle claimed in claim 8 or 9, wherein the suction plate comprises a suction plate body; a suction member provided in a lower portion of the suction plate body to be movable relatively to the suction plate body, the suction member being selectively attached to the bottom surface while a portion except a periphery of the suction member is raised upward; a suction boss protruding on an upper surface of the suction plate body and provided with a button for adjusting the attachment of the suction member; and an operating lever rotatably installed to the suction boss, the operating lever being rotated to maintain an attached state of the suction member in a state where the button is pressed.

11. The cradle claimed in claim 10, wherein the supporting link and the operating lever are rotatably installed at positions symmetric with each other about the suction boss, respectively, and selectively seated on a periphery region of the upper surface of the suction plate body.
